(19) United States
(12) Patent Application Publication
(10) Pub. No.: US 2016/0117365 A1
(43) Pub. Date: Apr. 28, 2016

(54) QUERY HOTNESS AND SYSTEM HOTNESS METRICS

(71) Applicant: HEWLETT-PACKARD DEVELOPMENT COMPANY, L.P., HOUSTON, TX (US)

(72) Inventor: Eric OWHADI, Tomball, TX (US)

(21) Appl. No.: 14/526,359

(22) Filed: Oct. 28, 2014

(51) Int. Cl. G06F 17/30

(52) U.S. Cl. CPC G06F 17/30442; G06F 17/30404

(57) ABSTRACT

A query signature is computed for each of a plurality of database queries. The time duration of at least some of the queries is determined. The determined time durations are normalized. A system hotness metric is computed for query signatures other than a first query signature based on an average of normalized time durations for the query signatures other than the first query signature. A query hotness metric for the first query signature is computed based on division of an average of the normalized time durations for the first query signature by the system hotness metric.

### BACKGROUND

Many clients may access a centralized database over a network. The database may be, for example, a Structured Query Language (SQL) database which is accessed with SQL queries from the clients. Each client may run its own unique client code. At the point in the code in which the client code needs to access the SQL database (e.g., to add data, retrieve data, update data, etc.), the client code generates SQL-formatted queries that are then transmitted over the network to the SQL database. A client may experience a slowdown of the database. That is, the client's queries may take increasingly longer to execute.

### BRIEF DESCRIPTION OF THE DRAWINGS

For a detailed description of various examples, reference will now be made to the accompanying drawings in which:

FIG. 1 shows a system in accordance with various examples;

FIG. 2 shows an implementation of a query profile tool in accordance with various examples;

FIG. 3 shows another implementation of a query profile tool in accordance with various examples;

FIG. 4 shows yet another implementation of a query profile tool in accordance with various examples;

FIG. 5 shows yet another implementation of a query profile tool in accordance with various examples;

FIG. 6 shows a method in accordance with various examples;

FIG. 7 shows yet another method in accordance with various examples;

FIG. 8 shows an example of query metric data in accordance with various examples; and

FIG. 9 shows a graphical example of query metric data in accordance with various examples.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct wired or wireless connection. Thus, if a first device couples to a second device, that connection may be through a direct connection or through an indirect connection via other devices and connections.

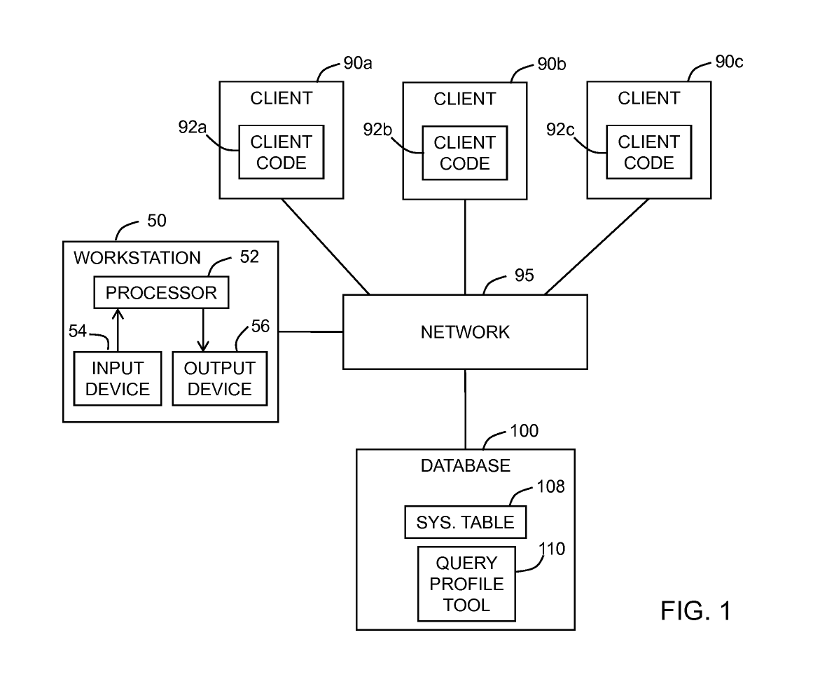

FIG. 1 illustrates an example in which multiple clients 90a, 90b, and 90c are able to access a centralized database 100 via a network 95. Each client 90a-90c may be any type of a computing device such as a desktop computer, server computer, etc. Client code runs on each client. Thus clients 90a, 90b, and 90c each include client code 92a, 92b, and 92c as shown. The client code of each client may be compiled from a different programming language and may different from each other in terms of functionality. For example, client code 90a may be different than client code 90b or 90c in terms of functionality and, even for similar functionality, different in implementation. Each client code 92a-92c may issue queries to the database 100 via network 95 for various purposes. There are numerous types of queries of the database 100. Examples of queries include selecting data in the database, inserting data, retrieving data, updating data, etc.

If one or more types of database queries begin to slow down, a database specialist may attempt to diagnose and fix the performance problem. To do that the specialist needs to understand the nature of the problem. The problem may be global in nature in that all clients are experiencing a slowdown because, for example, there are simply too many clients attempting to simultaneously access the database. The slowness problem instead might be unique to a particular client or unique to a particular type of query. To diagnose the problem and in accordance with the examples set forth herein, the database specialist uses monitoring software to profile and analyze the database queries.

The implementations described herein are directed to a tool that monitors the various queries to the database 100. The tool is shown in FIG. 1 as the query profile tool 110. The query profile tool 110 monitors and processes the incoming database queries as described below. A workstation 50 may be used to permit a user to use and interact with the query profile tool 110. The workstation 50 includes a processor 52 coupled to an input device 54 (e.g., a keyboard, mouse, etc.) and an output device 56 (e.g., a display). The query profile tool 110 may run on a computing resource separate from, but accessible to, the workstation 50, or may run on the workstation itself.

The database 100 may be implemented in accordance with any of variety of types of databases. In one example, database 100 may be implemented as a Structured Query Language (SQL) database. One of the challenges in monitoring queries to SQL databases (and other types of database implementations) is that it may be difficult to easily discern the type of query from the query itself. Each query may be formed as a character string. There may not necessarily be any particular character string to search for in the full query to discern the type of query. Further, two queries may be syntactically a little different but result in the same database access. Thus, monitoring the queries to determine whether a particular type of query has become slow is difficult. The query profile tool 110 addresses this issue.

Query profile tool 110 standardizes the queries to remove some or all subtle syntactical differences between similar queries. A query signature is then computed for each standardized query in such a way that a common signature can be calculated for all queries that standardize to the same syntax. In one example, the query signature computed for each standardized query is based on the Cyclic Redundancy Check 32 (CRC32) that can be computed for each such standardized query. Once each query is standardized and a query signature computed, the time durations of queries of common query signatures are processed as described herein. The time duration of a query is the time from initial submission of the query to the database 100 to the completion of the query. The time durations may be normalized to permit disparate queries of inherently different time durations to be compared. That is, some queries typically may take 60 milliseconds to execute while other, more complex queries may take minutes to execute. The standardization process, query signatures computation, and time duration normalization facilitate the query profile tool 110 to inform a database administrator or other person as to, for example, whether a particular query is slow or whether the system as a whole is slow.

References are made herein to SQL databases. However, as noted above, the database 100 may be implemented as a database other than an SQL database.

SQL databases include system tables (e.g., system table 108) into which queries are stored as well as, for each query, the start and stop times. The query profile tool 110 may use the information from the system table. For example, the time duration of a given query can be calculated as the difference between start and stop times. In other implementations, the query profile tool 110 uses queries and their start and stop times from sources other than the system tables. For example, the system tables may have been copied to another database for long term storage and the query profile tool 110 may access the copy.

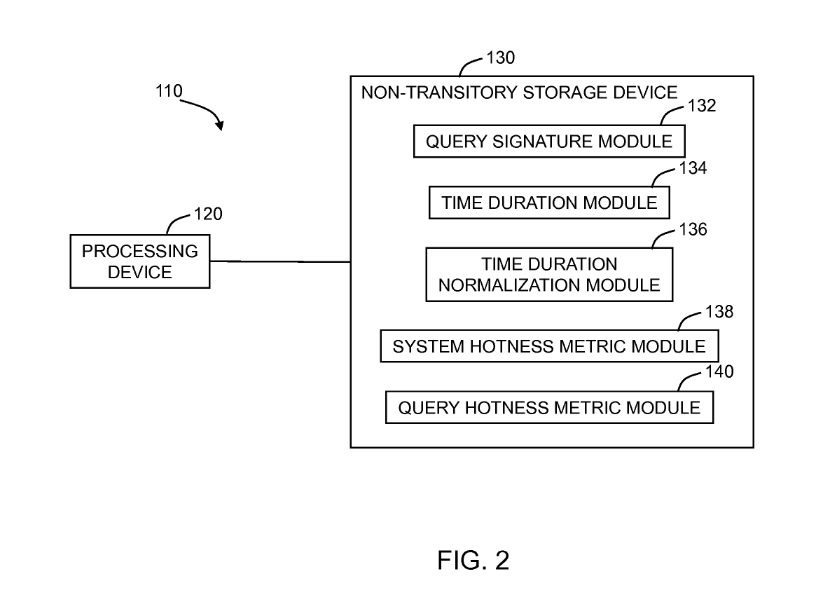

FIG. 2 illustrates an example of the query profile tool 110. As shown, the query profile tool 110 includes a processing resource 120 coupled to a non-transitory storage device 130. The processing resource 120 is implemented as a single hardware processor, multiple hardware processors, a single computer, or a network of computers. The non-transitory, storage device 130 includes volatile storage (e.g., random access memory), non-volatile storage (e.g., solid state storage, magnetic storage, optical storage, etc.) or combinations thereof. The storage device 130 contains machine executable instructions that may be executed by the processing resource 120. The machine instructions include various software modules 132, 134, 136, 138, and 140 that, when executed by the processing resource 120, cause the processing resource to perform various operations as described below. The software modules 132-140 may be implemented as separate modules, or two or more of all of the software modules may be implemented as a single software module. To the extent any functionality described herein is attributable to one of the software modules, it should be understood that such functionality is implemented by the processing resource 120 executing the software module.

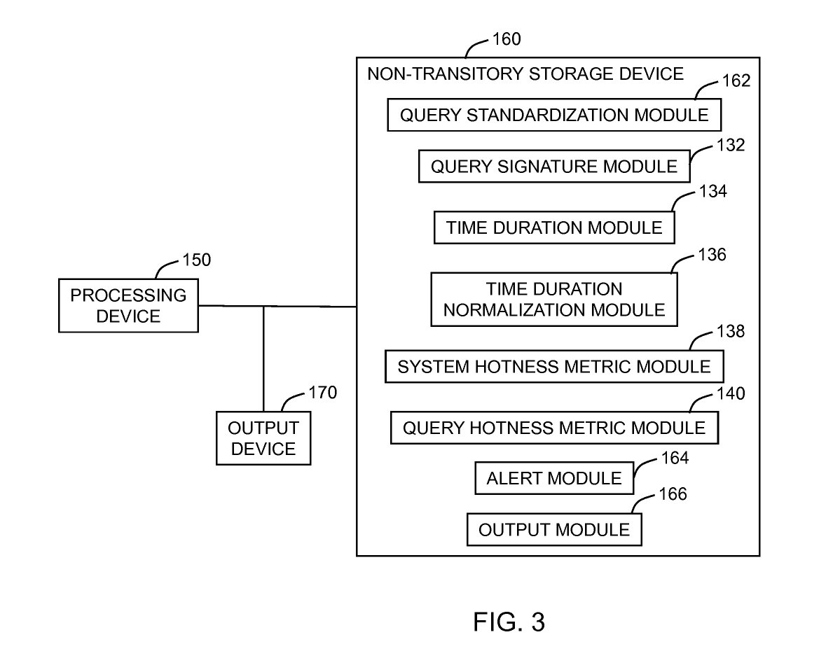

The query signature module 132 computes a query signature based on each of a plurality of database queries. Similar database queries may compute to the same query signature and disparate database queries may compute to different query signatures. Each query signature may be computed for the database queries themselves or standardized versions of the database queries. The standardization process is described below with reference to FIG. 3. Computing query signatures based on standardized database queries permits queries that attempt to perform the same task, albeit possibly in different ways, compute to the same query signature. The number of queries which compute to the same query signature indicates the number of queries that perform the same function.

Any of a variety of techniques may be used to compute a query signature for a given database query. One example of a suitable signature is the CRC32 computed based on the query.

The time duration module 134 determines the time duration of at least some of the queries. In one example, the time duration of a given query can be computed based on the difference between the start time and end time of the query.

The time duration normalization module 136 normalizes the time durations determined by the time duration module 134. Any suitable technique for normalizing the time durations so as to be able to compare and process disparate queries is acceptable. The following is a description of one example of time duration normalization. For each different query signature, the time duration normalization module computes the mean (μ) and standard deviation (σ) of the time durations for the various queries that compute to that particular query signature. Each time duration for the queries of a given query signature may be normalized using the following normalization function:

$$f ( {x}_{i} ) = 1 + \frac{{x}_{i} - μ}{( \sqrt{2 π} ) * σ}$$

where xᵢ is time duration and p and a are the mean and standard deviation of the ith different query signature. The normalizing function transforms the time duration data so that their average is 1 and standard deviation is 1/\sqrt{2π} and thus comparing the data and their averages across disparate queries is possible. Other means and standard deviation values are possible as well. For a time duration that happens to be exactly at the average of all time durations for that query signature, the normalized value for that time duration will be 1. A time duration that is a little greater than the average will be a little over 1 (e.g., 1.1), while a time duration that is little less than the average will be less than 1 (e.g., 0.85).

The system hotness metric 138 module computes a system hotness metric for a plurality of query signatures based on an average of normalized time durations for such query signatures. In some examples the system hotness metric is computed as the average of the normalized time durations for the plurality of query signatures of interest.

The query hotness metric module 140 can be computed for a particular query signature of interest (referred to herein as the “first query signature” for ease of explanation). The query hotness metric module 140 computes the query hotness metric for the first query signature by averaging the normalized time durations for the first query signature and then dividing that value by the system hotness metric. That is,

$$query hotness = \frac{ave . of normalized time duratons of query of interest}{system hotness} .$$

In the example in which a query hotness metric is computed for the first query signature, the system hotness metric may be computed without the time duration data of the first query signature. For example, if a user is interested in analyzing the n (e.g., 20) most often executed queries and the first query signature is one of those n most executed queries, the system hotness metric may be the average of the normalized time duration of the remaining 19 query signatures. By removing the normalized time duration data of the first query signature from the system hotness metric, the first query signature can be evaluated against the system as a whole without the “system” hotness metric itself being influenced by the normalized time duration data of first query signature.

FIG. 3 shows another example of a query profile tool in which a processing resource 150 is coupled to a non-transitory storage device 160 and to an output device 170. As above, the processing resource 150 is implemented as a single hardware processor, multiple hardware processors, a single computer, or a network of computers.

The non-transitory, storage device 160 includes volatile storage (e.g., random access memory), non-volatile storage (e.g., solid state storage, magnetic storage, optical storage, etc.) or combinations thereof. The storage device 160 contains machine executable instructions that may be executed by the processing resource 150. The machine instructions include various software modules, some of which are the same as described above. The software modules include the query signature module 132, the time duration module 134, the time duration normalization module 136, the system hotness metric module 38, and the query hotness metric module 140, as well as a query standardization module 162, an alert module 164, and an output module 166. The software modules 132-140 and 162-166 may be implemented as separate modules, or two or more of all of the software modules may be implemented as a single software module. To the extent any functionality described herein is attributable to one of the software modules, such functionality is implemented by the processing resource 150 executing the software module.

The output device 170 may be any suitable output device such as computer display. The output module 166 causes data, graphs, etc. to be provided to the output device. Examples of outputs provided to the output device 170 are presented below.

The functionality implemented by the query signature module 132, the time duration module 134, the time duration normalization module 136, the system hotness metric module 38, and the query hotness metric module 140 may be as described above.

The query standardization module 162 standardizes the queries to produce standardized queries. The query signature module 132 may compute query signatures (e.g., using CRC32) based on the standardized queries. Each query may be a character string. An example of a query standardization implemented by the query standardization module 162 is to perform any, some or all of the following for each query:
upper case each character string (i.e., replaced each lower case letter with its upper case equivalent);
remove single line comments;
remove multiple line comments;
for each signed or unsigned numeric value, if any, replace each such signed or unsigned numeric value by a predetermined alphanumeric character;
for each Boolean literal, if any, replace each Boolean literal by the predetermined alphanumeric character;
for each null literal, if any, replace each such null literal by the predetermined alphanumeric character;
for each character string that is single quote delimited, if any, replace each such single quote delimited string by the predetermined alphanumeric character; and
for each IN statement containing one or more literals, if any, replace the one or more literals by the predetermined alphanumeric character.
   The predetermined alphanumeric character mentioned above may the lower case letter ‘a’ in one example.

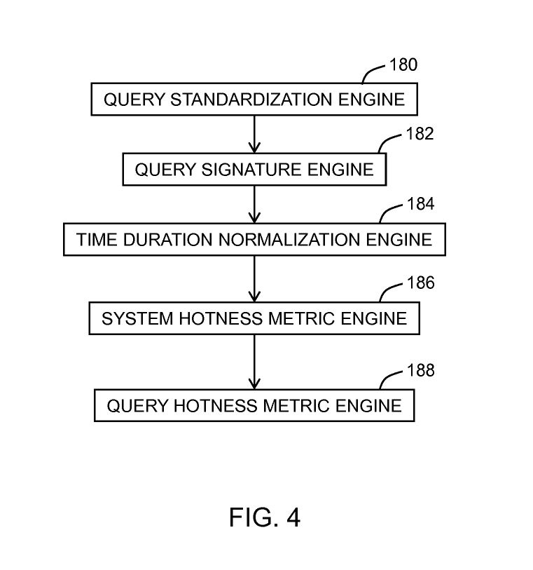

FIG. 4 shows an example of the query profile tool 110. The illustrative implementation of FIG. 4 includes a query standardization engine 180, a query signature engine 182, a time duration normalization engine 184, a system hotness metric engine 186, and a query hotness metric engine 188. Each engine 180-188 is implemented as a processing resource (e.g., processing resources 120, 150) executing a corresponding software module. For example, the query standardization engine 180 is implemented as the processing resource 150 executing the query standardization module 162 and performs the functions attributed above to the query standardization module 162. The query signature engine 182 is implemented as the processing resource 150 executing the query signature module 132 and performs the functions attributed above to the query signature module 162. The time duration normalization engine 184 is implemented as the processing resource 150 executing the time duration module 134 and the time duration normalization module 136 and performs the functionality attributed above to those modules. The system hotness metric engine 186 is implemented as the processing resource 150 executing the system hotness metric module 138 and performs the functions attributed above to the system hotness metric module. The query hotness metric engine 188 is implemented as the processing resource 150 executing the query hotness metric module 140, and performs the functions attributed above to that module.

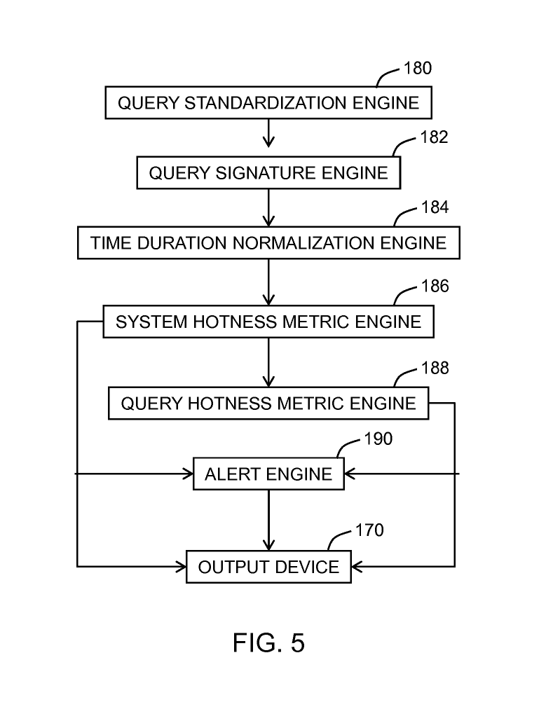

FIG. 5 shows another example of an implementation of the query profile tool 110. The implementation of FIG. 5 includes the query standardization engine 180, a query signature engine 182, a time duration normalization engine 184, a system hotness metric engine 186, and a query hotness metric engine 188. These engines are described above with respect to FIG. 4 and thus their description is not repeated here. The implementation of FIG. 5 also includes an alert engine 190 which provides alerts to the output device 170. The alert engine 190 is implemented as a processing resource (e.g., processing resource 120, 150) executing machine instructions. The alerts may be visual and/or audible.

The alert engine 190 receives data from either or both of the system hotness metric engine 186 and the query hotness metric engine 188, and generates any of a variety of alerts based on such data. For example, an alert for a given query signature may be generated based on the query hotness metric for that signature exceeding the mean plus three times the standard deviation. The mean and the standard deviation of the normalized time duration values for each query signature are 1 and 1/\sqrt{2π}, respectively. As explained previously, the query hotness metric is the ratio of the average of the normalized time durations for a given query signature to the system hotness metric. The numerator and denominator in this ratio include averages of data that has been normalized to have a mean of 1 and a standard deviation of 1/\sqrt{2π}. Thus, nominally, the query hotness metric is itself a value 1. An alert may be generated when the query hotness value exceeds

$$1 + ( 3 ) ( \frac{1}{\sqrt{2 π}} ) .$$

That the query hotness metric increases above 1 indicates that either the average time duration of the query of interest is increasing, or the average time duration of all other queries is decreasing, or both. An increasing query hotness metric indicates that the time duration of that query is increasing on average relative to the average time duration of the other queries. The alert threshold of

$$1 + ( 3 ) ( \frac{1}{\sqrt{2 π}} )$$

can be adjusted as desired. In another example, the alert engine 190 may generate an alert for the system hotness metric. If the system hotness metric exceeds

$$1 + ( 3 ) ( \frac{1}{\sqrt{2 π}} ) ,$$

then an alert may generated as that value for the system hotness metric may indicate that the database is generally running abnormally slow.

Another alert may be generated by the alert engine 190 based on the system hotness metric itself exceeding an alert threshold. The alert threshold for this purpose may be

$$1 + ( 3 ) ( \frac{1}{\sqrt{2 π}} )$$

or a different value.

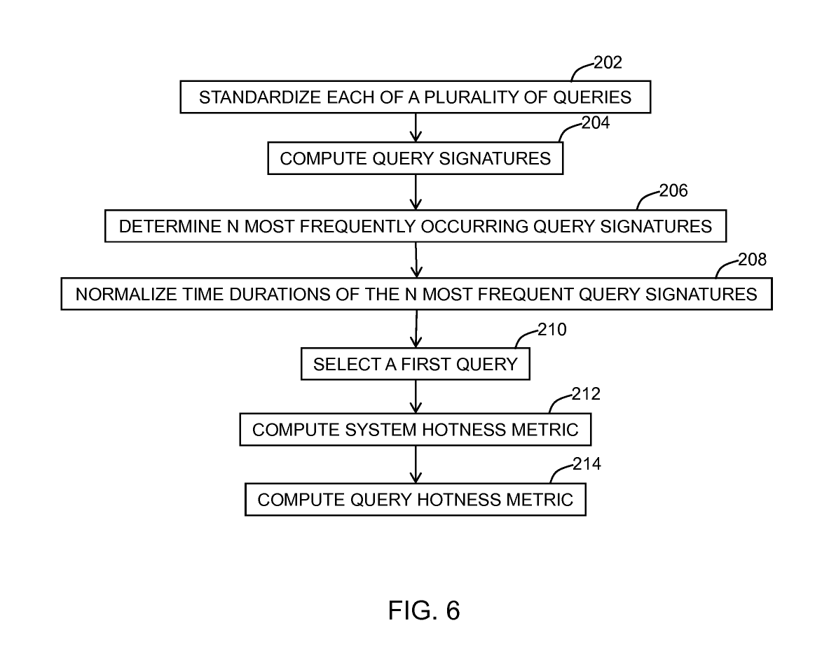

FIG. 6 illustrates a method in accordance with an example. The operations shown in FIG. 6 can be performed in the order shown or in a different order. Further, two or more of the operations may be performed in parallel rather than sequentially. The operations may be performed by a processing resource (e.g., processing resource 120, 150).

At 202, the method includes standardizing each of a plurality of queries to a database to generate standardized queries. Examples of how queries may be standardized are provided above. At 204, the method includes computing a query signature for each standardized query. The CRC32 algorithm can be used to compute the query signature.

At 206, the method includes determining the n most frequently occurring query signatures. In some examples n is 20, although n can be a number other than 20. At 208, the method further includes determining the time duration of each query of the n most frequently occurring query signatures. The method also includes normalizing the time durations of each query of the n most frequently occurring query signatures (208). The normalizing function provided above is an example of a normalizing function that may be used for this purpose.

At 210, the method includes selecting a first query signature. The first query signature may be any of the query signatures computed at 204. A system hotness metric may be computed at 212 for some or all other query signatures other than the first query signature by averaging their normalized time durations. The query signatures whose normalized time durations are included in the system hotness metric computation may include all other query signatures (other than the first query signature) or all other query signatures in the top n most frequently occurring queries (other than the first query signature).

The query hotness metric may be computed at 214. This metric may be computed by dividing an average of the normalized time durations for the first query signature by the system hotness metric.

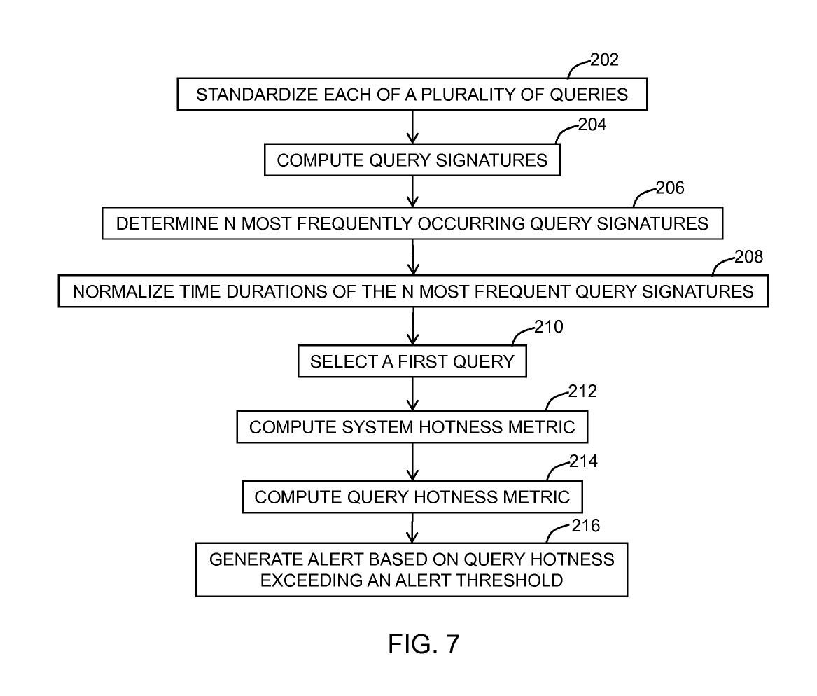

FIG. 7 shows a method in accordance with another example. The method of FIG. 7 is similar to that of FIG. 6 in that operations 202-214 are included. Explanation of those operations is not repeated there. At 216, the method of FIG. 7 includes generating an alert based on the query hotness exceeding an alert threshold (e.g.,

$$1 + ( 3 ) ( \frac{1}{\sqrt{2 π}} )$$

). The alert may be provided to the output device for visual and/or audible presentation.

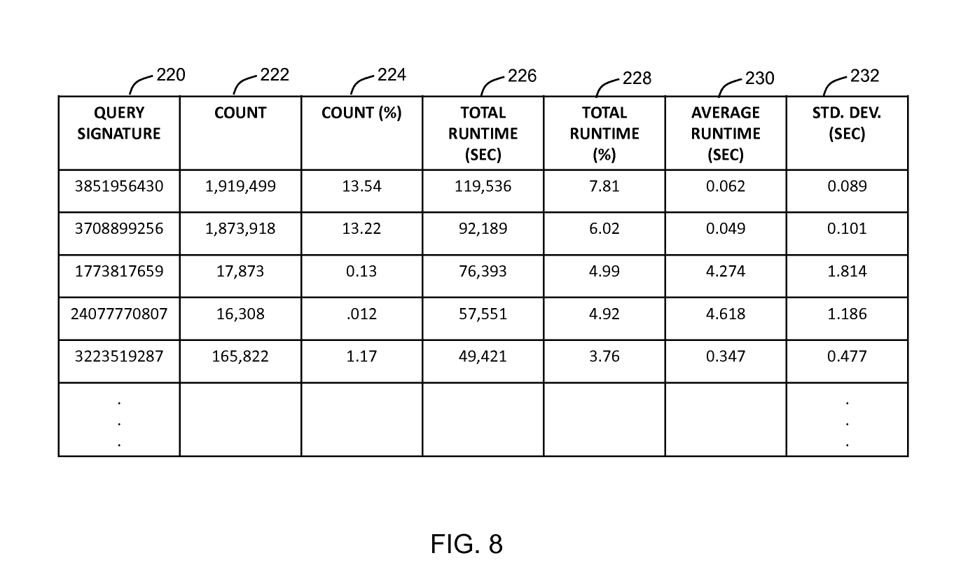

The following is an example of a use-case for the query profile tool. FIG. 8 illustrates a portion of table in which various query signatures 220 and associated data are shown. These data may have been collected and processed over a user-defined period of time (e.g., 2 days, 2 weeks, etc.). The query signatures 220 are calculated as described herein. For example, incoming queries to the database 100 are standardized and a query signature is computed (e.g., CRC32) for each standardized query. The query standardization and query signature module 162 and 132, respectively are used for this purpose.

The number of instances of each query signature (count 222) is shown for each query signature. For example, the first listed query signature is “3851956430” and, over the user-specified time period, a query that computed to that particular query signature occurred 1,914,499 times representing a count percentage 224 of 13.54% (i.e., 13.54% of all queries were this particular query).

Run times for each query may be computed by computing the difference between the start and end time for a give query. The total aggregate runtime for all of the queries corresponding to each query signature is listed at 226. Thus, query signature 3851956430 has a total runtime of 119,536 seconds which, as a total runtime percentage 228, is 7.81% of the total runtime of all queries in the data set. The average runtime over the user-specified time period is shown at 230 and, by way of example, is 0.062 seconds for query signature 3851956430. The standard deviation is shown at 232.

The table shown in FIG. 8 may be sorted in various ways by the user selecting one of the column headings. A user might want to drill down and analyze a particular query signature. The target query signature may be one of the most often invoked queries and the user may want to figure out whether the query is trending upward or downward in its execution time relative to the system as a whole. The analysis by a user may be initiated by an alert, such as the alerts illustrated above.

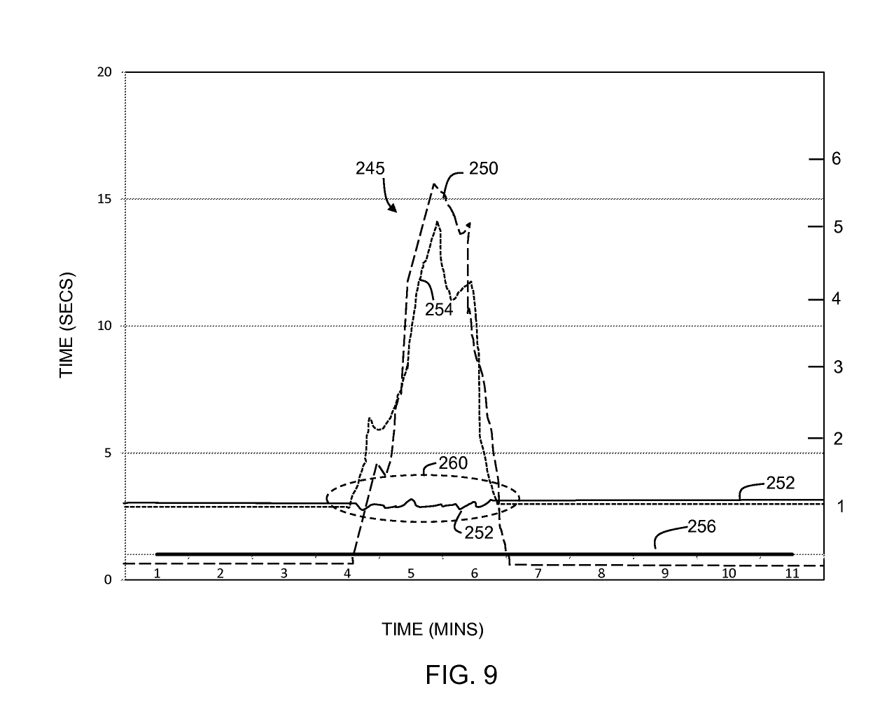

The user may select one query in particular to further analyze by selecting that query, for example, from the list of query signatures in FIG. 8. A graphical analysis of the selected query is illustrated in the example of FIG. 9. In the example of FIG. 9, four graphs 250, 252, 254, and 256 are shown. Time is along the x-axis. The left-hand vertical axis is time in, for example, seconds and the right-hand vertical axis is dimensionless.

Graph 250 (large dashed line) represents the average query runtime measured in units of seconds (left-hand vertical axis). This average is computed for each of a plurality of time windows, the length of which is the average runtime of the query signature rounded to the nearest minute (and rounded up to 1 minute if otherwise below 1 minute). During each time interval, the time duration data for queries occurring in that particular time interval are used to compute an average time duration. The resulting time duration averages (averaged over the length of each time interval) are shown by the graph 250.

As can be seen in the example of FIG. 9, the average time duration is fairly small, but increases at 245, and then drops back down as shown. The question a user might want to know is why did the average run time of that particular query signature increase. The answer might be that there is something unique to that particular query causing it take an increasingly longer period of time to execute, or the system as a whole may be running slowly (e.g., too many simultaneous users).

Graph 252 (solid line) is the query hotness metric computed for the selected query signature. The query hotness metric may be the ratio of the average of the normalized time durations for selected query signature to the system hotness metric. Two graphs 254 and 250 are shown generally at 245 as deviating substantially from their nominal baselines. The system hotness metric is shown by graph 254 (small dashed line) and graph 250 is represents the average query runtime (as noted above). As can be seen, the system hotness metric increases dramatically at 245, but the query hotness metric does not increase dramatically. This indicates the average runtime of the selected query metric has increased due to the system running hot in general, and not as a result of something unique occurring to the selected query signature. Consequently, the query hotness metric does not increase dramatically as is indicated by graph 252 at 260.

The above discussion is meant to be illustrative of the principles and various implementations of the present subject matter. Numerous variations and modifications will become apparent to those skilled in the art once the above disclosure is fully appreciated. It is intended that the following claims be interpreted to embrace all such variations and modifications.

What is claimed is:

1. A non-transitory storage device containing machine instructions that, when executed by a processing resource, causes the processing resource to:
compute a query signature for each of a plurality of database queries, wherein similar database queries compute to the same query signature and disparate database queries compute to different query signatures;
determine the time duration of at least some of the queries;
normalize the determined time durations;
compute a system hotness metric for query signatures other than a first query signature based on an average of normalized time durations for the query signatures other than the first query signature; and
compute a query hotness metric for the first query signature based on division of an average of the normalized time durations for the first query signature by the system hotness metric.

2. The non-transitory storage device of claim 1 wherein, when executed, the machine instructions cause the processing resource to standardize each of the plurality of database queries to produce standardized database queries and to compute the query signatures based on the standardized database queries.

3. The non-transitory storage device of claim 2 wherein each query is represented by a character string, and, when executed, the machine instructions cause the processing resource to standardize each of the plurality of queries by performing at least one of:
upper case each character string;
remove single line comments;
remove multiple line comments;
for each signed or unsigned numeric value, if any, replace each such signed or unsigned numeric value by a predetermined alphanumeric character;
for each Boolean literal, if any, replace each Boolean literal by the predetermined alphanumeric character;
for each null literal, if any, replace each such null literal by the predetermined alphanumeric character;
for each string that is single quote delimited, if any, replace each such single quote delimited string by the predetermined alphanumeric character; and
for each IN statement containing one or more literals, if any, replace the one or more literals by the predetermined alphanumeric character.

4. The non-transitory storage device of claim 2 wherein each query is represented by a character string, and, when executed, the machine instructions cause the processing resource to standardize each of the plurality of queries by performing each of:
upper case each character string;
remove single line comments;
remove multiple line comments;
for each signed or unsigned numeric value, if any, replace each such signed or unsigned numeric value by a predetermined alphanumeric character;
for each Boolean literal, if any, replace each Boolean literal by the predetermined alphanumeric character;
for each null literal, if any, replace each such null literal by the predetermined alphanumeric character;
for each string that is single quote delimited, if any, replace each such single quote delimited string by the predetermined alphanumeric character; and
for each IN statement containing one or more literals, if any, replace the one or more literals by the predetermined alphanumeric character.

5. The non-transitory storage device of claim 1 wherein, when executed, the machine instructions cause the processing resource to compute each query signature by computation of a cyclic redundancy check 32 (CRC32) value.

6. The non-transitory storage device of claim 1 wherein, when executed the machine instructions cause the processing resource to normalize the time durations of each query based on an average time duration and standard deviation of the queries corresponding to a common query signature.

7. The non-transitory storage device of claim 5 wherein, when executed, the machine instructions cause the processing resource to normalize the time durations of each query by computation of:
$$f ( {x}_{i} ) = 1 + \frac{{x}_{i} - μ}{( \sqrt{2 π} ) * σ}$$
wherein xᵢ is the ith query, μ is the average time duration, and σ is the standard deviation.

8. The non-transitory storage device of claim 5 wherein, when executed, the machine instructions cause the processing resource to generate an alert based on the query hotness exceeding the average plus three times the standard deviation.

9. The non-transitory storage device of claim 1 wherein, when executed, the machine instructions cause the processing resource to generate an alert based on the query hotness exceeding an alert threshold.

10. The non-transitory storage device of claim 1 wherein, when executed, the machine instructions cause the processing resource to compute the query hotness metric by computing a different query hotness metric in each a plurality of time periods, each time period corresponding to the average time duration of the first query signature.

11. The non-transitory storage device of claim 1 wherein each database query is a structured query language (SQL) query.

12. A system, comprising:
a query standardization engine to standardize each of a plurality of queries to a database to generate standardized queries;
a query signature engine to compute a query signature for each of the standardized queries, wherein similar database queries compute to the same query signature and disparate database queries compute to different query signatures;
a time duration normalization engine to determine the time duration of at least some of the queries and to normalize the determined time durations;
a system hotness metric engine to compute a system hotness metric for query signatures other than a first query signature based on an average of normalized time durations for the query signatures other than the first query signature; and
a query hotness metric engine to compute a query hotness metric for the first query signature based on division of an average of the normalized time durations for the first query signature by the system hotness metric.

13. The system of claim 12 wherein each query is represented by a character string and wherein the query standardization engine is to perform at least one of:
upper case each character string;
remove single line comments;
remove multiple line comments;
for each signed or unsigned numeric value, if any, replace each such signed or unsigned numeric value by a predetermined alphanumeric character;
for each Boolean literal, if any, replace each Boolean literal by the predetermined alphanumeric character;
for each null literal, if any, replace each such null literal by the predetermined alphanumeric character;
for each string that is single quote delimited, if any, replace each such single quote delimited string by the predetermined alphanumeric character; and
for each IN statement containing one or more literals, if any, replace the one or more literals by the predetermined alphanumeric character.

14. The system of claim 12 wherein the time duration normalization engine is to normalize the determined time durations to normalized values whose average is 1 and standard deviation is 1/sqrt(2π).

15. The system of claim 12 wherein the time duration normalization engine is to normalize the determined time durations based on:
computation of the average time duration and standard deviation of each query signature; and
computation of:
$$f ( {x}_{i} ) = 1 + \frac{{x}_{i} - μ}{( \sqrt{2 π} ) * σ}$$
wherein xᵢ is the ith query, and μ is an average and σ is a standard deviation of queries of the same query signature as the ith query.

16. The system of claim 12 further including an alert engine that generates an alert based on the query hotness metric exceeding an alert threshold.

17. A method, comprising:
standardizing, by a processing resource, each of a plurality of queries to a database to generate standardized queries;
computing, by the processing resource, a query signature for each standardized query;
determining, by the processing resource, the n most frequently occurring query signatures;
determining, by the processing resource, the time duration of each query of the n most frequently occurring query signatures;
normalizing, by the processing resource, the time durations of each query of the n most frequently occurring query signatures;
selecting, by the processing resource, a first query signature;
computing, by the processing resource, a system hotness metric for all query signatures other than the first query signature by averaging their normalized time durations;
computing, by the processing resource, a query hotness metric for the first query signature by dividing an average of the normalized time durations for the first query signature by the system hotness metric.

18. The method of claim 17 wherein each query is represented by a character string, and wherein standardizing each of the plurality of queries includes at least one of:
upper casing each character string;
removing single line comments;
removing multiple line comments;
for each signed or unsigned numeric value, if any, replacing each such signed or unsigned numeric value by a predetermined alphanumeric character;
for each Boolean literal, if any, replacing each Boolean literal by the predetermined alphanumeric character;
for each null literal, if any, replacing each such null literal by the predetermined alphanumeric character;
for each string that is single quote delimited, if any, replace each such single quote delimited string by the predetermined alphanumeric character; and
for each IN statement containing one or more literals, if any, replacing the one or more literals by the predetermined alphanumeric character.

19. The method of claim 17 wherein normalizing the time durations of each query comprises:
computing the average time duration and standard deviation of each query signature; and
computing:
$$f ( {x}_{i} ) = 1 + \frac{{x}_{i} - μ}{( \sqrt{2 π} ) * σ}$$
wherein xᵢ is the ith query and μ is an average and σ is a standard deviation of queries of the same signature as the ith query.

20. The method of claim 17 further comprising generating an alert based on the query hotness exceeding an alert threshold.
